(19) United States
(12) Patent Application Publication
(10) Pub. No.: US 2002/0198010 A1
(43) Pub. Date: Dec. 26, 2002

(54) System and method for interpreting and commanding entities

(76) Inventors: Asko Komsi, Cambridge, MA (US); Tarja Teppo, Cambridge, MA (US)

Correspondence Address: LINDA BEACH, NOKIA, INC., 6000 CONNECTION DRIVE, MD-1-4-755, IRVING, TX, 75039, US

(21) Appl. No.: 09/894,163

(22) Filed: Jun. 26, 2001

(51) Int. Cl. H04Q 7/20

(52) U.S. Cl. 455/466; 455/463

(57) ABSTRACT

A system and method for interpreting and commanding entities is provided. The system includes an entity player for invoking an entity, wherein the entity includes a plurality of methods, an entity editor connected to the entity player, and at least one control device connected to the entity player, wherein the entity player invokes the entity methods in accordance with the control device. The method includes selecting an entity wherein the entity includes a plurality of commands that are associated with the entity, and selecting at least one entity command. The step of selecting entity commands may be performed through the use of an entity editor.

### RELATED CASES

This application is related to co-pending U.S. patent application Ser. No. ______ (Attorney Docket No. NC30512) filed on Aug. 15, 2000, entitled ______; co-pending U.S. patent application Ser. No. ______ (Attorney Docket No. NC30538) filed on Jun. 1, 2001, entitled System and Method for Interactive Entity Communication; co-pending U.S. patent application Ser. No. ______ (Attorney Docket No. NC30539) filed on Jun. 1, 2001, entitled System and Method for Entity Communication of Advertisements; co-pending U.S. patent application Ser. No. ______ (Attorney Docket No. NC30540) filed on Jun. 1, 2001, entitled System and Method for Entity Discovery; co-pending U.S. patent application Ser. No. ______ (Attorney Docket No. NC30541) filed on Jun. 1, 2001, entitled System and Method for Entity Personalization; co-pending U.S. patent application Ser. No. ______ (Attorney Docket No. NC30556) filed on Jun. 26, 2001, entitled System and Method for Implementing Entity Bookmarks; co-pending U.S. patent application Ser. No. ______ (Attorney Docket No. NC30557) filed on Jun. 26, 2001, entitled System and Method for Entity Programming; co-pending U.S. patent application Ser. No. ______ (Attorney Docket No. NC30575) filed on Jun. 26, 2001, entitled System and Method for Interpreting and Commanding Entities; co-pending U.S. patent application Ser. No. ______ (Attorney Docket No. NC30576) filed on Jun. 26, 2001, entitled System and Method for Entity Visualization of Text Messages; co-pending U.S. patent application Ser. No. ______ (Attorney Docket No. NC30577) filed on Jun. 26, 2001, entitled Entity Reply Mechanism; co-pending U.S. patent application Ser. No. ______ (Attorney Docket No. NC30578) filed on Jun. 26, 2001, entitled System and Method for Entity Optimization; all of which are assigned to and commonly owned by Nokia, Inc, and are herein incorporated by reference.

### FIELD OF THE INVENTION

This invention relates generally to messaging in a communications network and more specifically, to a system and method for entity messaging.

### BACKGROUND

Wireless communications have become very popular because of their convenience and availability. Messaging services such as SMS enable users to send and receive short messages. Although such messaging services are convenient, they are limited in their functionality and available options for personal expression. What is needed is a system and method for messaging that makes use of improvements in technology and allows for expanded possibilities for personal expression.

### SUMMARY

A system and method for commanding entities is provided. In an embodiment of the present invention, the system comprises an entity player for invoking an entity, wherein the entity includes a plurality of methods, an entity editor connected to the entity player, and at least one control device connected to the entity player, wherein the entity player invokes the entity methods in accordance with the control device. In an embodiment of the present invention, the method comprises selecting an entity wherein the entity includes a plurality of commands that are associated with the entity, and selecting at least one entity command. The step of selecting entity commands may be performed through the use of an entity editor. A method for interpreting entities is provided and includes the steps of retrieving, by an entity-enabled device, an entity having a plurality of commands wherein the entity-enabled device includes an entity player for interpreting the commands; determining, by the entity player, whether the commands are compatible with the entity-enabled device; and interpreting, by the entity player, the compatible commands on the entity-enabled device. The method may ignore commands that are not compatible with the entity-enabled device. Alternatively, the method may interpret incompatible commands using commands that are compatible with the entity-enabled device.

### BRIEF DESCRIPTION OF THE DRAWINGS

FIG. 1 is a block diagram of a system for entity messaging in accordance with an embodiment of the present invention.

FIG. 2 is a diagram illustrating components of an entity in accordance with an embodiment of the present invention.

FIG. 3 is a diagram illustrating examples of visual components that may be included with an entity in accordance with an embodiment of the present invention.

FIG. 4 is a diagram illustrating examples of entity language syntax in accordance with an embodiment of the present invention.

FIG. 5 is illustrating an example of how entity commands and parameters may be mapped to entity actions in accordance with an embodiment of the present invention.

FIG. 6 is illustrating an example of how entity commands may be mapped to entity actions in accordance with an embodiment of the present invention.

FIG. 7 is illustrating an example of how entity commands may be mapped to entity actions in accordance with an embodiment of the present invention.

FIG. 8 is illustrating an example of how entity commands and parameters may be mapped to entity actions in accordance with an embodiment of the present invention.

FIG. 9 is a diagram illustrating software architecture in accordance with an embodiment of the present invention.

FIG. 10 is a diagram illustrating hardware architecture in accordance with an embodiment of the present invention.

FIG. 11 is a diagram illustrating a method for entity messaging in accordance with an embodiment of the present invention.

FIG. 12 is a diagram illustrating a method for entity messaging in accordance with an embodiment of the present invention.

FIG. 13 is a diagram illustrating a method for entity messaging that may be used be for advertising in accordance with an embodiment of the present invention.

FIG. 14 is a diagram illustrating a method for commanding an entity in accordance with an embodiment of the present invention.

FIG. 15 is a diagram illustrating a method for receiving an entity in accordance with an embodiment of the present invention.

FIG. 16 is a diagram illustrating a system and method for interactive entity communication in accordance with an embodiment of the present invention.

FIG. 17 is a diagram illustrating a system and method for entity discovery in accordance with an embodiment of the present invention.

FIG. 18 is a diagram illustrating a method for commanding an entity in accordance with an embodiment of the present invention.

### DETAILED DESCRIPTION

I. Overview

Messaging systems in wireless communications systems have become popular because of their convenience and availability. However, typically such systems are limited to the sending and receiving of short text messages. Short text messages have limited usefulness in terms of functionality and available options for personal expression. In order to expand the messaging functionality and the available options for personal expression, a system and method for entity messaging is disclosed in which various forms of media content, business methods, and technological advances in communication devices may be integrated into the messaging system. This system and method for entity messaging is programmable and may be used with a variety of devices and communication methods. Numerous messaging systems may be used in connection with embodiments of the present invention. Examples of such messaging systems include SMS, GPRS, multimedia messaging (MMS), packet data systems (used by CDMA), TDMA messaging, one-way and two-way paging, chat systems, instant messaging, and email.

For example, instead of sending only a text message, the user of a wireless terminal may send a package of content and functionality, called an entity, to another user who may display and invoke the entity at the receiving end. This entity may take on characteristics that have been programmed into it, and may, for example, appear on a wireless terminal display as an animated character. The animated character may include sounds and expressions that make the entity seem life-like. In an embodiment of the present invention, an entity may even be programmed to have personality and emotion, and to include functionality that will interact with other devices in such a way as to communicate information about that device back to the user.

A feature of the system and method for entity messaging is that it may be expanded to make use of new technologies and improvements in existing technologies. For example, as the bandwidth of network communications systems increases, entities may be enhanced to provide richer media content and functionality that was not previously available. Similarly, as improvements in technology result in the improved performance of communications devices, entities may be enhanced to take advantage of these technological improvements. For example, with increased memory and CPU power, entities may be created to include more media content that may be played back at higher speeds, resulting in a more pleasurable user experience.

I.A. System for Entity Messaging

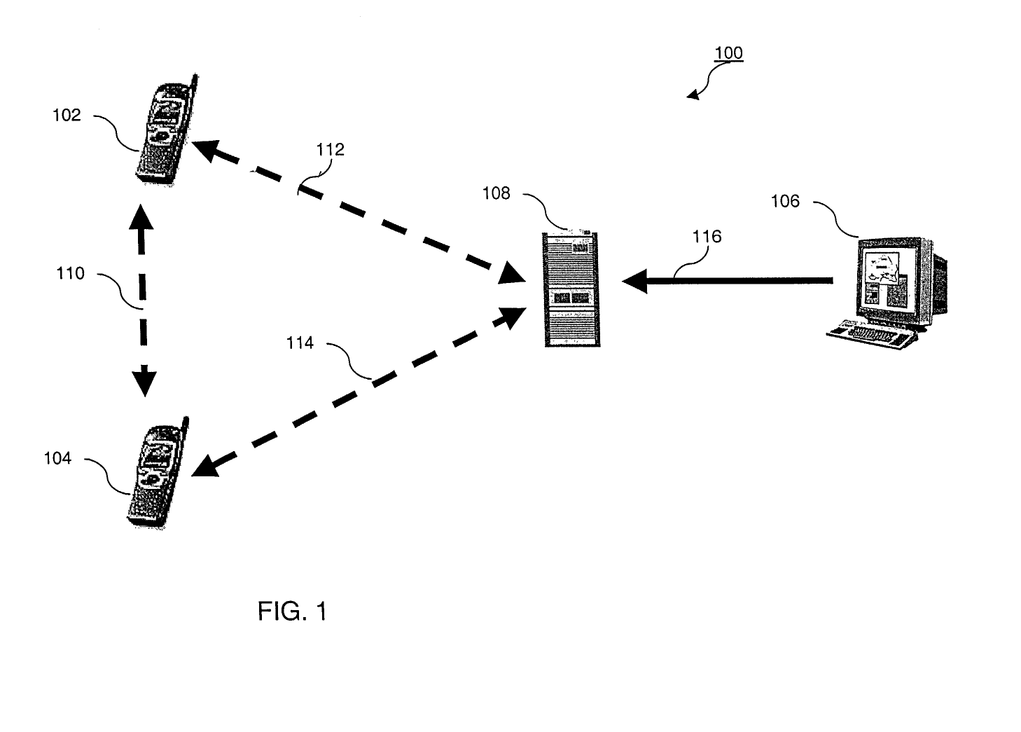

Referring to FIG. 1, a system for entity messaging 100 includes at least one entity-enabled device, wherein the entity-enabled device has some sort of communication capability and storage. Typically, the entity-enabled device is connected with at least one other device on a communication network. The entity-enabled device may include a data structure called an entity that may be stored and processed on the entity-enabled device. An entity-enabled device is a device that may store and process entities. Entity-enabled devices may include wireless terminals, cellular phones, computers, personal computers, microprocessors, personal digital assistants (PDAs), or any other programmable device. In an embodiment of the present invention, an entity messaging system 100 includes entity-enabled devices 102, 104, 106, and 108 that are connected as shown by connections 110, 112, 114, and 116. Connections 110, 112, and 114 are wireless connections and connection 116 is a wireline connection. The entity (not shown) is communicated over the network in order to provide enhanced messaging. This enhanced messaging may include, for example: sending media content, providing enhanced personal expression of messages, providing information about another device on the network, or controlling the actions of another device. The implementation of the system may expand to include new technologies for network communication, including wireline and wireless networks.

The system provides capability for creating, modifying, commanding, and distributing entities. The system may be expanded to take advantage of new technologies and performance improvements in devices that operate on a communications network. For example, an entity may be created on personal computer 106, distributed to server 108 via connection 116, downloaded over connection 112 by a user with wireless terminal 102, and then sent to the user of wireless terminal 104 over wireless connection 110. Similarly, an entity may be downloaded over connection 114 from server 108 by a user having wireless terminal 104, and then sent from wireless terminal 104 to wireless terminal 102 over wireless connection 110. Server 108 may be a dedicated entity server or may be one of a plurality of servers from which users may download entities over the network. The wireless connections may be implemented to conform to any appropriate communication standard including 3G, Bluetooth, or Infrared.

I.B. Method for Entity Messaging

A method for entity messaging includes functions such as creating an entity, modifying an entity, retrieving an entity from a source, commanding an entity, and distributing an entity, and sending an entity to another device that is capable of receiving it. Steps that may be performed by various embodiments of a method for entity messaging in accordance with the present invention will be discussed further below in the sections on usage of entities. These functions may be implemented on entity-enabled devices such as wireless terminals 102, 104, personal computers 106, or servers 108, and may be expanded to include devices that are not entity-enabled through means that are described in further detail below. Distribution and retrieval of entities may occur over wireless connections 110, 112, 114, or over a wireline connection 116.

II. Entity

An entity is the basic message component of a system and method for entity messaging. An entity may be described as a package of content and functionality that may be defined in numerous ways, depending on how it is created, designed, modified, and commanded. A default entity may be defined to include a minimal set of content and functionality and may be associated with a particular entity-enabled device. The extent of an entity's functionality as it appears to a receiving user may be a function of available technology, bandwidth, and resources available on a user's device and on a communication network.

II.A. Entity Components

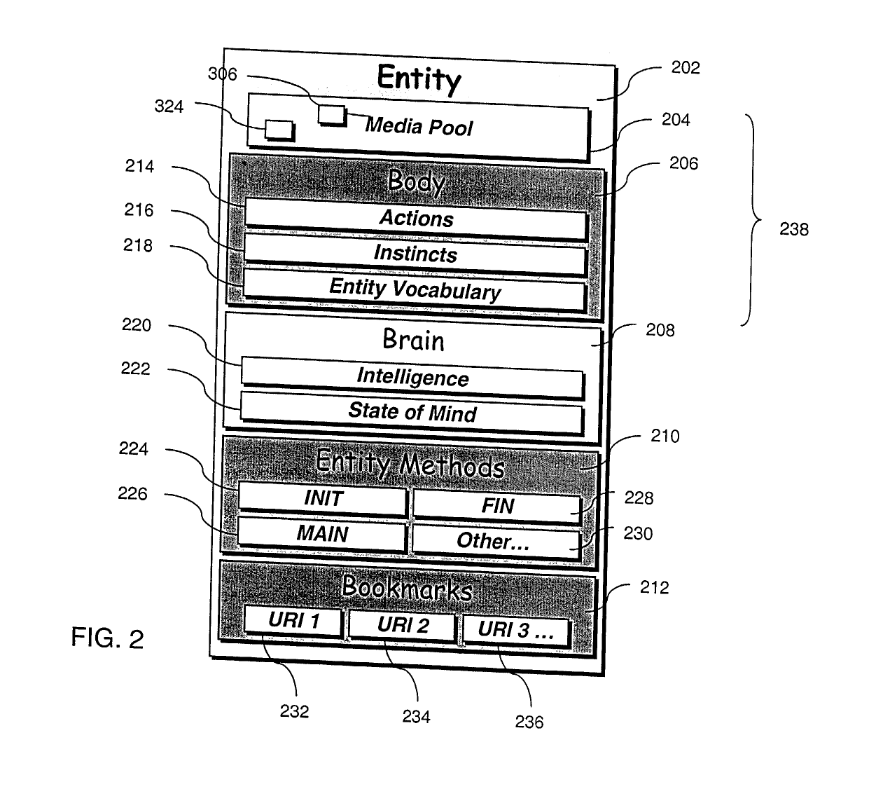

Referring to FIG. 2, an entity 202 may include a pool of media content 204, a body 206, a control center or brain 208, one or more methods 210, and bookmarks 212. An entity 202 may include any subset of these components or all of them, depending on the desired content and functionality, and on the functionality available to the entity-enabled device on which the entity is used.

II.A.1. Media Pool

An entity may include a repository or pool of media content 204 that may be used to define the entity's looks and behavior. The look of an entity will typically appear on the display of the device on which the entity 202 is displayed. Behavior of an entity may include playing some audio or video in connection with commanding an entity to do something. The content in the media pool 204 may be used by other parts of an entity such as the body 206. For example, if an entity defines an animated character that plays audio or video content, the audio or video content would reside in the media pool 204.

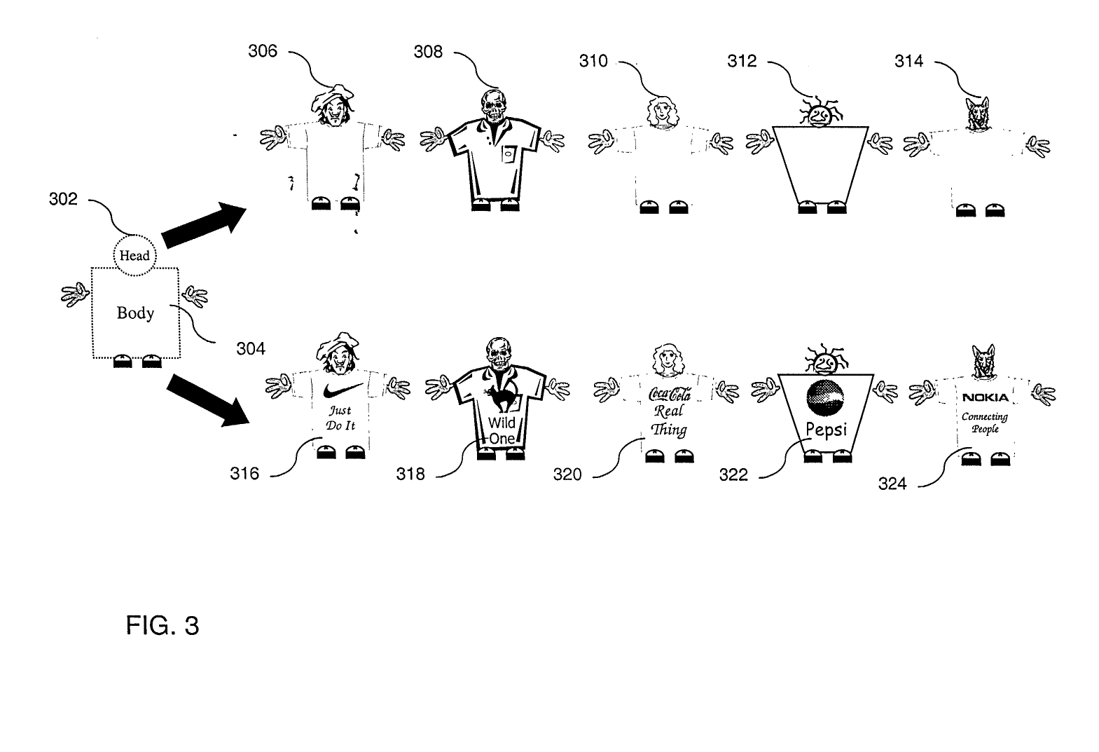

The media content in media pool 204 may be in any digital form, including bitmaps, animation, audio or video clips in any appropriate format (JPEG, MPEG, MP3, GIF, TIFF, etc.), text, images, or any other content that may be displayed or played on a device. The visual content may be stored in media pool 204 as visual components that may be used to define an entity's look. For example, in an entity 202 that appears as an animated character, visual components may be used to define the character's body parts (head, body, feet, hands, etc.) and clothing (t-shirt, shoes, etc.). Visual components may used to add advertising logos to the entity and/or to the pictorial representation of an animated character associated with an entity. For example, visual component 306 is shown as the head of a character, and visual component 316 is displayed as a t-shirt with the Nokia™ logo on it. Visual components are described further in the discussion of FIG. 3 below.

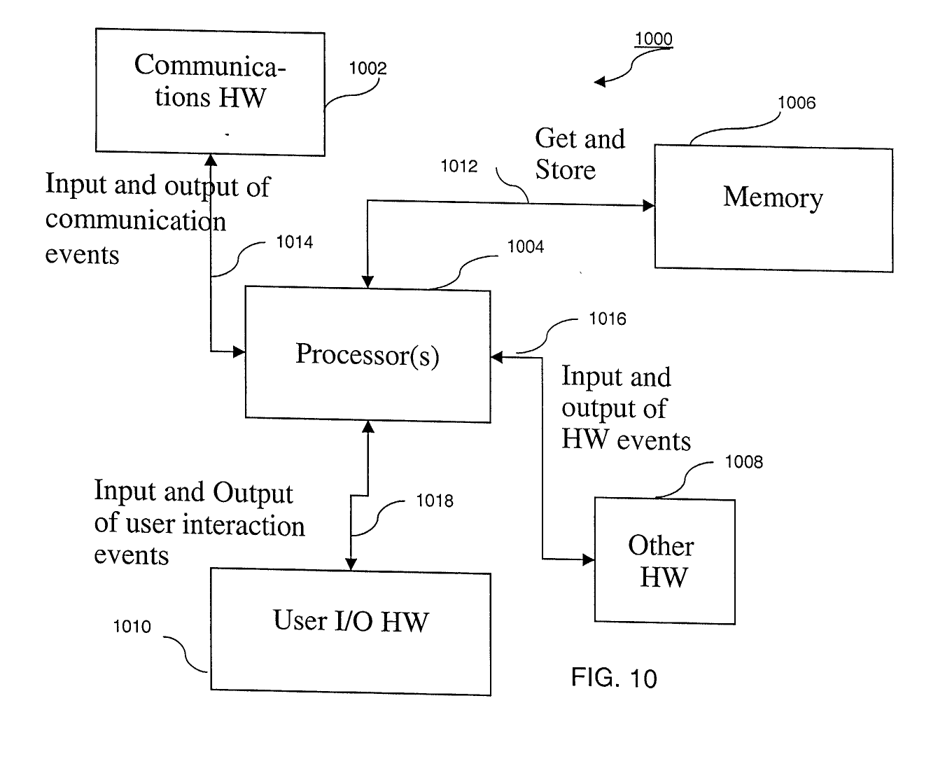

The content in the media pool 204 may be embedded inside the entity 202 so that the entity 202 may be stored, sent, downloaded, and received as a self-contained unit. This self-contained unit also may provide a mechanism for transport layer optimization by allowing the creator of an entity to decide which content in the media pool 204 is sent as part of an entity 202 and which content is downloaded only when needed. Optimization is discussed further below in connection with discussion of the entity execution environment shown in FIG. 10. If a user desires to make a reference to content that is located elsewhere, for example, on the network, then a location or a pointer to a location may be defined as a bookmark 212, as described in further detail below.

The media pool 204 does not typically include the intelligence of how the various clips and content fit together in the context of a particular entity. The body 206 and brain 208 typically contain this sort of information, as described below. The content in the media pool 204 may come from any source, may be implemented as part of a default entity 238, and may be changed or updated at any time. A self-contained entity 202 would generally have some content available in the media pool 204. Another way to reference content in the context of entity messaging is to define bookmarks 212, which are described in further detail below.

The size of the media pool may be expanded as the available resources increase. For example, an entity-enabled device having lots of memory would be able to accommodate entities having large media pools, whereas devices with smaller memories would only be able to accommodate smaller media pools. Other resources that may have an effect on the usable size of an entity's media pool include the bandwidth of the communications network and the CPU power of the devices that process the entity.

II.A.2. Body

The body 206 defines how an entity 202 is presented and what actions the entity 202 may perform. Body 206 may include actions 214, instincts 216, and vocabulary 218. The body 206 may include one or more visual components. The one or more visual components may represent parts of an animated character and may include, for example, a visual component, a body, hands, and feet. These visual components may be personalized as desired.

FIG. 3 illustrates some example of visual components 302-324 that may be stored in media pool 204. Such visual components may be used define the look of various body parts of an entity and may be personalized in accordance with an embodiment of the present invention. A basic entity such as the default entity 238 may include a visual component 302 that looks like a character's head and a visual component 304 that looks like a character's body or a like a shirt on a character's body. Visual components 302 and 304 may be implemented as objects that may be stored in media pool 204, for example, bitmaps, and may be manipulated through the use of entity commands appropriate to those objects.

For example, bitmaps representing eyes and mouth may be included in an object associated with a typical visual component 302. A typical default entity integrated into a phone may include one or more visual components such as visual components 302 and 304 that are specific to that phone. FIG. 3 illustrates some examples of how an entity may be defined or personalized through the use of visual components. Visual component 302 may be personalized by using entity commands, entity creation and/or entity editing tools to replace visual component 302 with any of a plurality of variations including visual components 306, 308, 310, 312, and 314. A large number of variations may be implemented, possibly limited only by the user's creativity or by the capability of the particular tools used to create the variations.

Similarly, visual component 304 may be personalized by using entity commands or entity creation and/or editing tools to replace visual component 304 with any of a plurality of variations including visual components 316, 318, 320, 322, and 324. Visual components 316, 320, 322, and 324 appears as shirts on animated characters, and show examples of how advertisements may be incorporated into the representation of an entity. In addition to visual components that appear as the heads and bodies (or shirts on bodies) of entity characters, the visual components associated with animations may include text, company logos, company names, etc. Also, various aspects of the visual components associated with the parts of entities may be changed. For example, the color of the shirt may be changed, sunglasses may be added on the face, etc. So the default entity and the animations are like templates that may be modified and replaced. The creation and modification of entities is discussed further below.

II.A.2.a. Entity Actions

Entity actions 214 may be used to define how an entity uses the content and local functions that are available, and how they are synchronized. The content available for actions 214 typically comes from the media pool 204. Local functionality includes functions that may be performed on the device where the entity is located, for example, making a phone call or sending a text message. Entity commands 218 may use various entity actions 214 to produce a particular result when commanding an entity. For example, an entity command such as “SAY” may make use of entity actions such as showing a particular GIF file from media pool 204 on the display and playing a sound file obtained from media pool 204.

II.A.2.b. Entity Instincts

Entity instincts 216 map the commands in the vocabulary 218 to the actions 214. This mapping defines the default behavior of the entity 202. In an example embodiment of the present invention, entity instincts 216 may be implemented as a table that maps entity commands to entity actions. The default mapping created by instincts 216 may be overridden by the brain 208, which is described in further detail below.

II.A.2.c. Entity Vocabulary

The entity vocabulary 218 is the set of commands that the entity understands. Commands from vocabulary 218 may be used to put together entity methods 210 or procedures that may be used to command the entity 202. If an entity is not commanded, then it does not do anything. A language called MonsterTalk defines the syntax and grammar of vocabulary 218. This language is described further below in connection with the discussions on entity language and the entity execution environment.

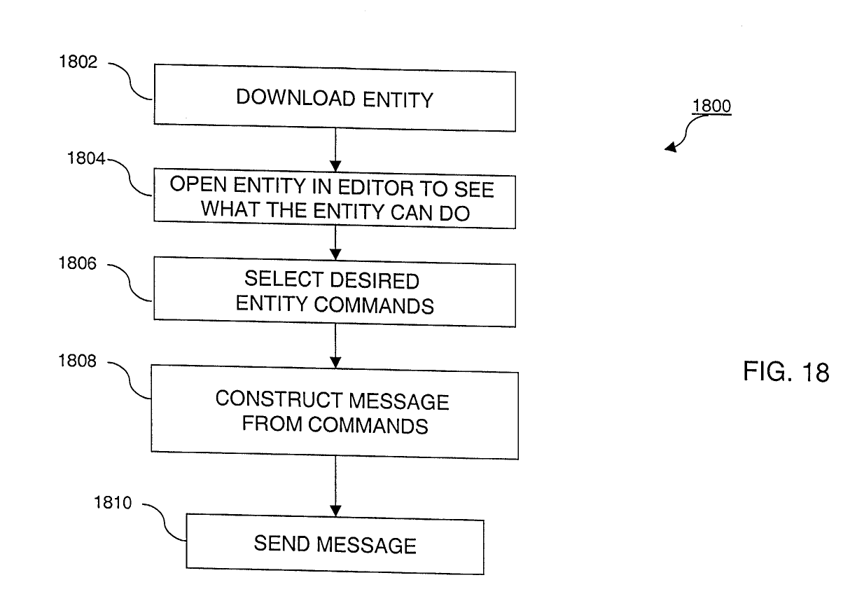

FIG. 18 shows a flowchart 1800 illustrating example steps in a method for commanding an entity. An entity may be downloaded, step 1802, from an entity storage location such as a server. The user may open that entity in an entity editor (described below) to find out what the entity is capable of doing, step 1804. The user may select a set of commands, step 1806, or may choose to use all of the commands available in the downloaded entity. The user may then construct a message using those entity commands, step 1808, and then send a message, step 1810, using an entity that may invoke the user's selected commands.

II.A.3. Entity Brain

The entity brain 208 defines how the entity 202 behaves and responds to commands. The brain 208 may include intelligence 220 and a state of mind 222. The brain 208 may be used to override the entity's instincts 216, described above, which define the entity's default behavior. If no brain 208 is defined in an entity 208 as in, for example, the default entity 238 described above, then the entity commands are mapped to entity actions 214 and instincts 216 as defined by body 206. If a brain 208 is defined, it may include intelligence 220 and a set of parameters known as the state of mind 222. The state of mind 222 is a set of facts or parameters upon which the logic of intelligence 220 may act or respond. The brain 208 may enable the entity 202 to interact with user interfaces, networks, and other devices through Application Programming Interfaces (APIs) that may be developed for this purpose.

II.A.3.a. Entity Intelligence

The intelligence 220 is logic or programs that may define what an entity may do or how an entity may respond when given a particular state of mind 222. This set of facts may be stored in state of mind 222 and operate as parameters for entity intelligence 220. The intelligence 220 of brain 208 may be implemented in any suitable programming language, for example, Java, C++, etc.

II.A.3.b. Entity State of Mind

The state of mind 222 of an entity 202 is a set of facts that may define how an entity behaves and responds given a particular context. The state of mind 222 may provide variations from default behavior and is meant to be analogous to “emotions” that may be associated with an entity 202.

In an embodiment of the present invention, the state of mind 222 may be implemented as a database. Such a database may include a set of facts or values that define characteristics such as age, color, date, time, etc. and may be used in countless ways for entity expression. For example, an entity 202 may include a state of mind 222 that defines the entity as always being sad on Mondays. If the entity the receives a facial expression command telling it to express happiness, for example, the SMILE command, the state of mind 222 may override that command and replace the entity's expression with a sad expression, for example by issuing the CRY command. In another example, a date-associated media clip such as the tune “Happy Birthday” might be included with an entity 202 and invoked on an entity-enabled device on a user's birth date. Any number of variations on this theme may be implemented through the state of mind 222.

II.A.4. Entity Methods

The entity methods section 210 of an entity 202 is a collection of individual entity methods 224, 226, 228, 230, etc., Entity methods 210 may include messages, entity commands, or both, and may be executed automatically when the entity is invoked, or may be invoked explicitly when a request is made to execute them. Entity methods may be pre-defined or may be defined by a user. Entity methods may also be used in a system and method for advertising.

II.A.4.a. Examples: INIT, MAIN, FIN, Other . . .

Some examples of entity method include INIT 224, MAIN 226, and FIN 228. Other methods 230 may also be included to provide additional features. For example, a PREVIEW method may be added so that a user may preview an entity 202 prior to storing it, editing it, or sending it to another user. INIT method 224 may be included in the entity methods section 210 in order to initialize the entity 202 upon invocation. MAIN method 226 may include a message and/or entity commands. FIN method 228 may be included to provide a desired ending after the INIT and MAIN methods are run. For example, in an advertising context, when an advertising entity is invoked, an INIT method 224 may play an advertiser's jingle, a MAIN method 226 may be executed to implement a set of features relating to the advertiser, and at the end, a FIN method 228 may be executed to perform final operations such as sending the message “Goodbye” and displaying the URL for the advertiser's web site. A less intrusive alternative to displaying the URL this way would be to add the URL for the advertiser's company web site to the entity bookmarks 212. Entity bookmarks are described in more detail below.

An entity comes with a predefined INIT method 224 and a predefined FIN method 228, as mentioned in the advertising example above. User-defined methods may include, for example, a MAIN method 226 that contains a message and other methods 230. A minimal set of entity methods may include a message in MAIN 226, especially if there is not enough bandwidth available to include more. If there are no methods included in the entity at all, then the entity does not do anything because there are no methods to invoke. If one or more of the methods contained in the collection of entity methods 210 require functionality that is not available on a particular entity-enabled device, then the functionality that is not available may be ignored by the entity when it is invoked, or alternatively, the unsupported functionality may be implemented in a way that is consistent with the default entity 238 on that particular entity-enabled device.

II.A.5. Entity Bookmarks

An entity bookmark 212 is a collection of references that may be used to provide an addressing mechanism that allows the user an entity to access local or remote locations or services. In an embodiment of the present invention, bookmarks 212 may be, for example, Universal Resource Identifiers (URIs), as shown by bookmarks 232, 234, and 236. A URI is a compact text string that may point to an abstract or a physical resource. One or more URIs may be included in bookmarks 212.

II.A.5.a. URIs and How They May Be Used in the Context of Entities

URIs may point to a number of different locations of resources. For example, as shown in FIG. 2, there are three URIs: URI 1 232, URI 2 234, and URI 3 236. An entity 202 may include with a set of URIs that are specific to that entity. This set of bookmarks 212 may be used, for example, to denote web addresses, email addresses, or other Internet resources. in a specific example, a URI may point to a document such as RFC 2396, the Request for Comments document associated with URIs, which is located at http://www.ref-editor.org/.

Through the use of bookmarks 212, the recipient of an entity 202 may go to the links that are specified by the URIs. Upon selecting a particular bookmark 212, a user may perform any action that is appropriate to the selection of a URI. For example, a user may select a bookmark 212, execute the link associated with the URI, and view the received content associated with that particular URI. Bookmarks 212 may be implemented to include a label that may be used for quick identification of a URI if, for example, the URI is very long and cumbersome. The label may be used as a shortcut to get to the URI. A user may select a label for a bookmark 212, attempt to execute the URI request associated with that bookmark 212, and if unsuccessful, for example, if the URI is not accessible, error messages may be implemented to inform the user of the problem.

II.A.6. Example Terminology for Entities

In an example embodiment of the present invention, a set of terminology may be defined and used to refer to entities and their variations. This terminology may include the following: MoMo, MoMo Mascot, MoMo Nomad, MoMo Smartie, MoMoTalk, MoMoTalking, and Personalization. A MoMo may be defined as a character that performs animations in a device such as a phone. MoMos may be divided into various categories, including Mascots, Nomads, and Smarties.

A MoMo Mascot may be defined as a character that may be embedded in a device such as a phone. A MoMo Mascot may be defined as not having the ability to change its location or place. However, someone else may command the MoMo Mascot by sending an entity command such as MoMoTalking to the Mascot. A MoMo Nomad may be defined as an animation that may be customized in a device such as a phone to contain a user's personal message. This personal message may be sent from one device (such as a phone) to another device, through the use of a communication means such as MMS. A MoMo Smartie may be defined in a similar way as the MoMo Nomad but where the part of the Smartie may be updated by downloading. The ability to update the Smartie by downloading may provide the ability to introduce some intelligence.

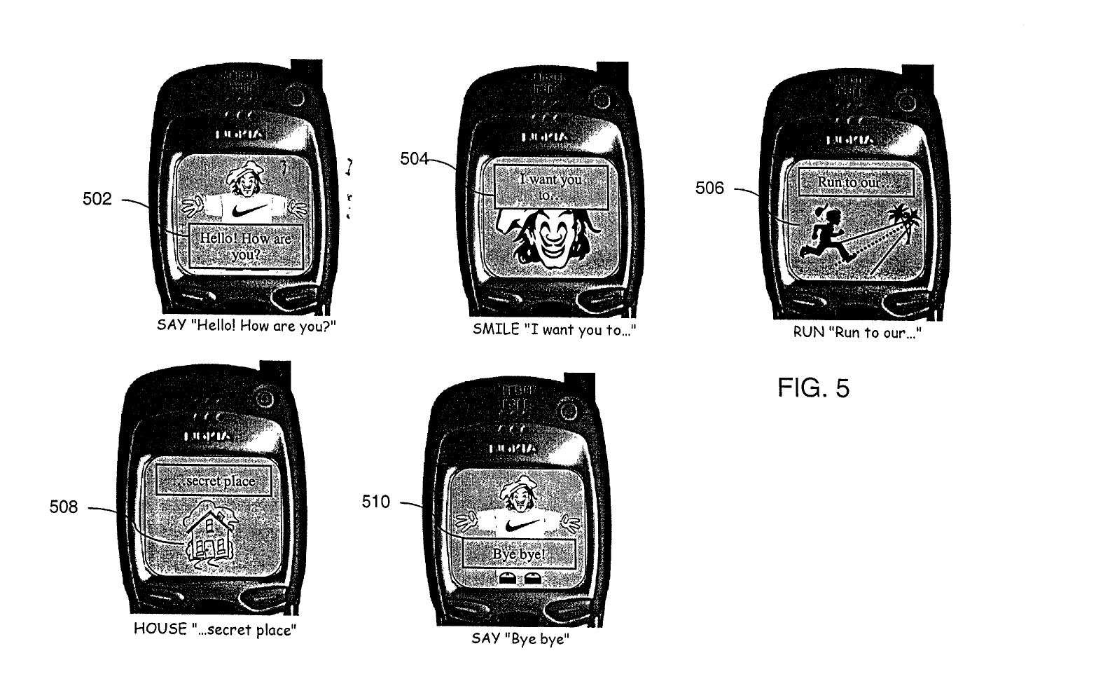

In an example emdodiment of the present invention, a set of terminology may also be defined to refer to the language of entites and their commands. For example, MoMoTalk may be defined as a language that users may use to create MoMoTalking for communication with a Mascot. MoMoTalk includes MoMo commands, or entity commands. A MoMo command is a single command from the set of available MoMoTalk or entity commands. Some examples of MoMoTalk commands may include JUMP, DRINK. The effect of entity commands such as MoMoTalk commands on the display of an entity-enabled device are shown in FIGS. 5-8, which are described more fully below. MoMoTalking may be defined as an SMS message that contains MoMoTalk. The MoMoTalk that a Mascot sends and/or receives may be called MoMoTalking. The way that a user communicates with a Mascot may also be called MoMoTalking.

Personalization may be defined as a method for changing the visualization of the animation of the Mascot. A mascot may be based on the multiple layers of pictures that may be changed as part of the animated character known as the MoMo. Thus, features of the MoMo, e.g., the Mascot's head may be changed easily through personalization. As part of the personalization method, a MoMo Skin may be defined as the package that is delivered to a device or phone for the purpose of Mascot personalization. This MoMo Skin may contain elements needed or desired for the personalization of the MoMo and may include, for example, variations on the Mascot's head, shirt, hands, feet, etc. Examples of such variations are illustrated and described further in the discussion of FIG. 3.

In order to obtain a MoMo for personalization, a MoMo may be downloaded through the use of a MoMo Download. For example, a MoMo Nomad may be downloaded to a device such as a phone so that the MoMo Nomad may be personalized. After the download, the Nomad may be personalized by telling the Nomad the message that it should convey. The terminology described above is merely exemplary of some possibilities for naming various entities and their functions, and is not intended to limit the scope of embodiments of the present invention.

II.B. Entity Language

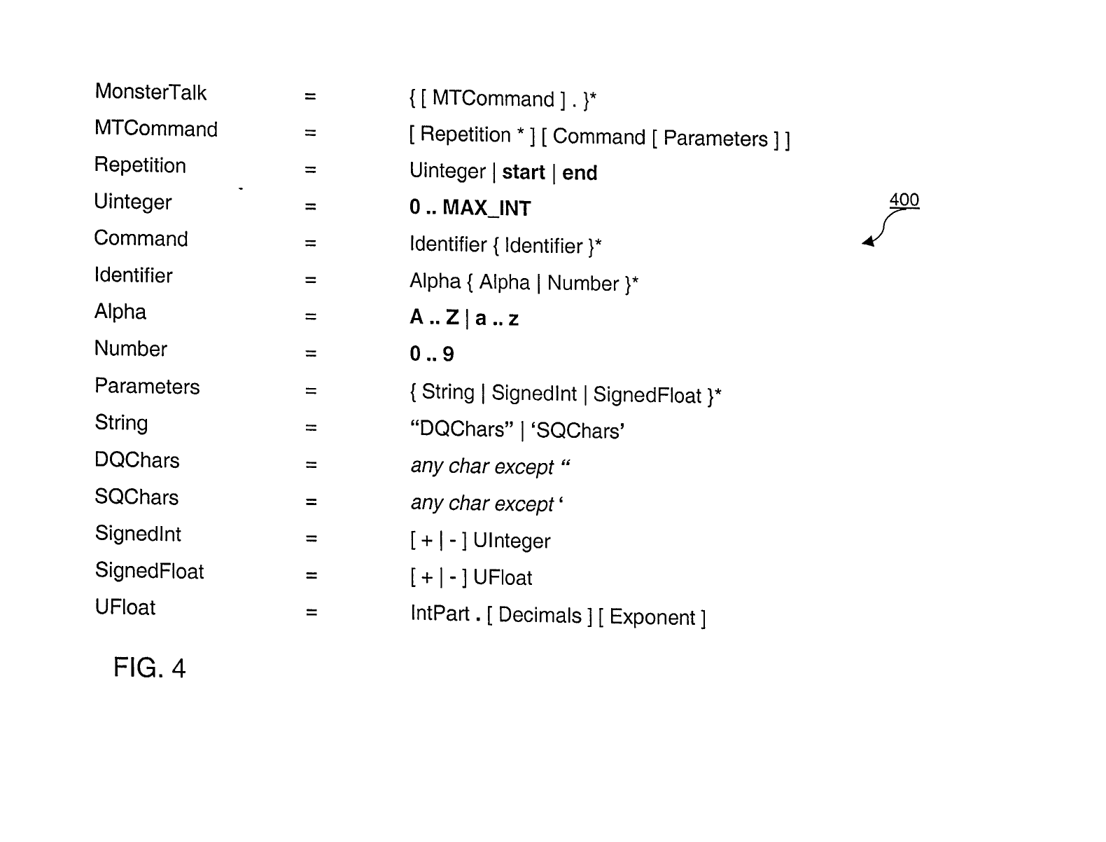

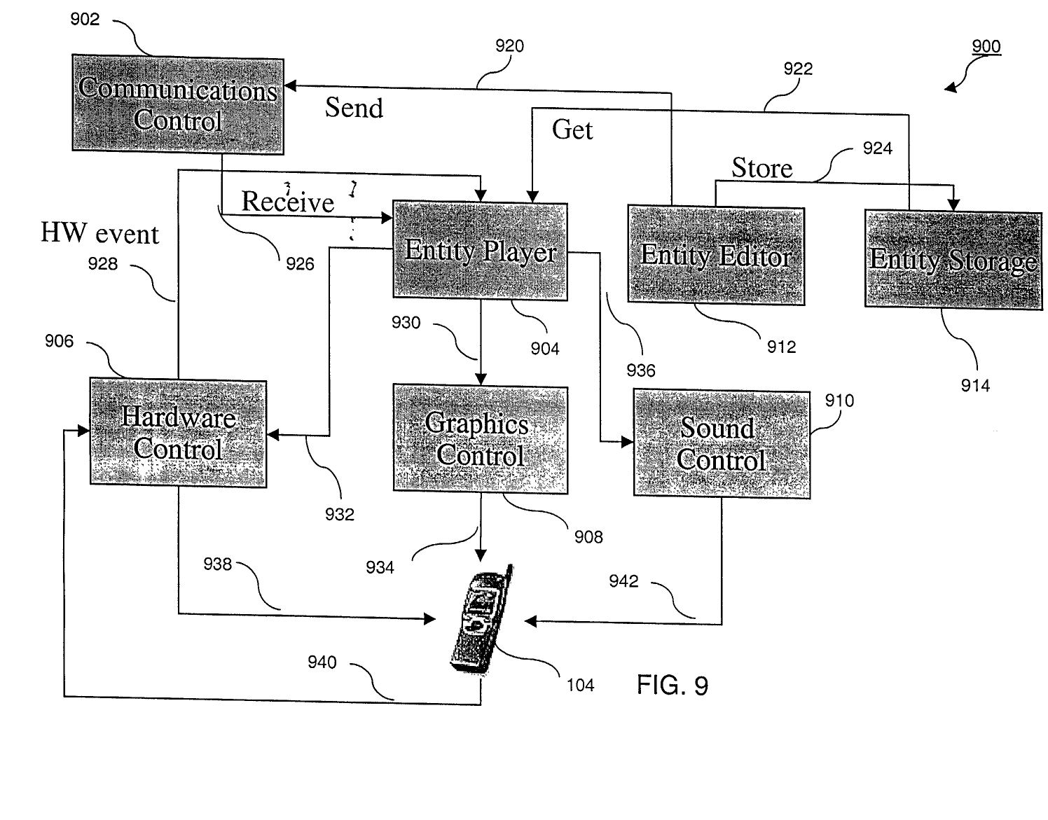

FIG. 4 illustrates some examples of entity language syntax 400 that may be used in accordance with an embodiment of the present invention. Entity commands, or vocabulary, may be used to map entity commands to entity actions, in accordance with syntax such as that shown by entity language syntax 400. An entity engine may be used to interpret the entity commands, or vocabulary. The entity engine and other associated architecture involved in the creation, modification, and invocation of entities is further described in the discussion of FIG. 9 below.

Entity language is designed for messaging and commanding an entity (Mobile Monster, a toy, a oven, a car etc.). Entity language is designed to be used by non-professional programmers. It is more like a commanding language than a programming language. An example of an entity language command may look like this:

SAY “Hi! How are you doing?”. HAPPY “Aren't u happy to hear from me!”. CALL “Call me” 5553421

The language includes commands may be executed in the order they are presented. Entity language includes an extensible command set. The language defines the syntax of the language and not the commands. A user may start with entity language and come up with a new set of commands that fit their communication and commanding needs. The syntax specifies the rules on how the commands may be defined and what kinds of parameters may be introduced. This enables the user of the language to create his own version of the language. The commands may be separated from the rest of the language elements. If the lexical and syntactical grammar of the entity language are defined correctly, the parser of entity language with any user selected command set can be parsed with the same parser that makes the development of an entity language interpreter straight forward: you can have a front end that understands entity language with any command set and a back end that understands the actual command set and the semantics of each command.

The following are some examples of a syntax (lexical & syntactic grammar) that specifies how the commands may be defined but not what they are:

The following examples relate to lexical grammar:

Identifier:=Char {Char|Num}

Char:=A-Z|a-z

Num:=0-9

String:=“{AnyChar}”

AnyChar:=Char|Num|SpecialChar

SpecialChar:=$|_|. . .

The following examples relate to syntactic grammar:

MonsterTalk::={Command Parameters.}

Command::=CommandName {CommandName}

CommandName::=Identifier

Parameters::={Parameter}

Parameter::=String|Number

Examples of commands that may work with the previous language specification include the following:

SMILE “Hi!”. JUMP HIGH. WAVE HAND “Yo!”. I RULE THE WORLD “Definitely”.

Examples of commands that may not be acceptable due to syntax problems include the following:

1SMILE, JUMP 3, WAVE $, I RULE THE WORLD 1+2

An entity-enabled device (a phone, a toy, a software program, a Mobile Monster, a toaster or other appliance, etc.) that wants to support entity language and to allow other entities or users to communicate with it may define their own command set, specify the semantics related to those commands and provide a mechanism for others to find out about the supported commands and their semantics. An example may include a phone that specifies the following commands:

CALL number=>Means that the phone will make a phone call to the given number

DISPLAY text=>Means that the given text is displayed in the phone display for 10 seconds

An entity-enabled device such as a phone may provide a software API, a messaging protocol, a manual with a section that describes the supported commands, etc. to inform the users of the device what specific entity command set the device supports. The device may also accept these commands in multitude of different ways: a specific entity message, a phone program that asks the user which commands he wants to execute, a software API to command the phone with entity language, etc. If the phone supports special entity messages then anyone could send it a message containing the commands that it supports. An example of such message may be the following:

DISPLAY “Hi Jude! I miss u!”. DISPLAY “Please call me”. CALL 5556745.

When an entity-enabled device receives such a message, it would show the two texts to the user first and then ask the user to make a call to the given number.

In an embodiment of the present invention, an example of how the entity methods may be used is illustrated by a sequence of entity commands and their associated parameters 502, 504, 506, 508, and 510, which are shown and described further below in the discussion of FIG. 5:

SAY “Hello! How are you?”. SMILE “I want you to . . . ”. RUN “Run to our . . . ”. HOUSE “. . . secret place”. SAY “Bye bye”.

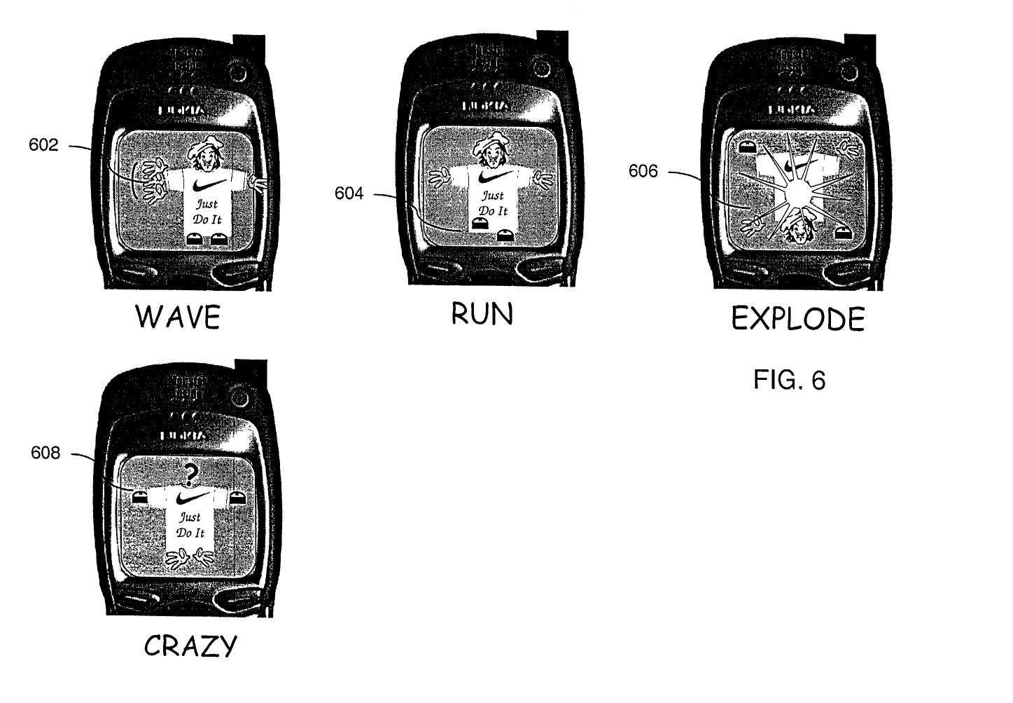

In an embodiment of the present invention, some examples of entity commands and their associated entity actions are shown and described in the discussion of FIG. 6:

WAVE. RUN. EXPLODE. CRAZY.

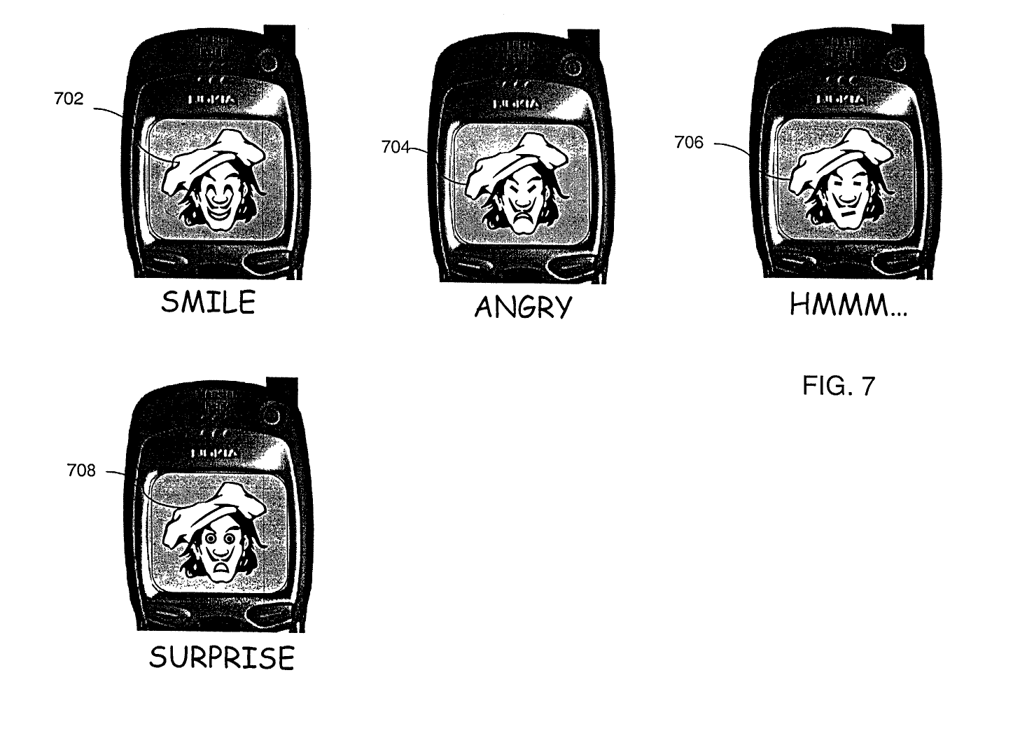

In an embodiment of the present invention, more examples of entity commands are shown and described in the discussion of FIG. 7. These commands may be used to show expressions of emotions on the faces of animated characters associated with an entity and may include the following:

SMILE. ANGRY. HMMM. SURPRISE.

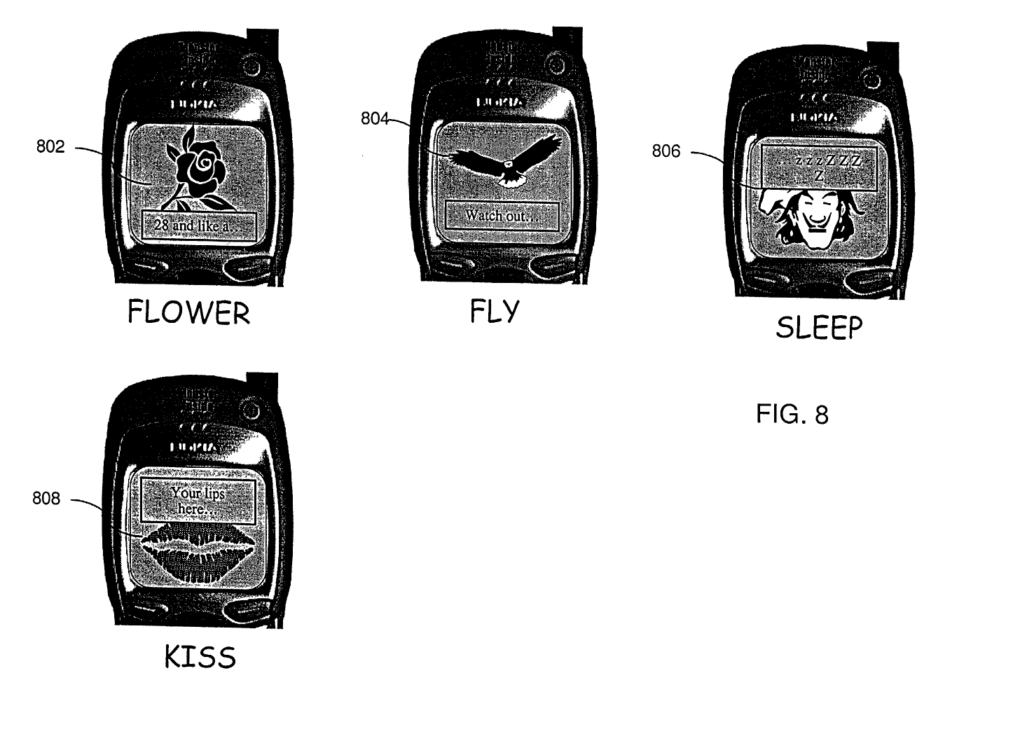

In an embodiment of the present invention, entity commands and parameters associated with those commands may be selected and shown as described in the discussion of FIG. 8 below. These entity commands and parameters may appear as shown in FIG. 8 and may be defined as follows:

FLOWER “28 and like a . . . ”. FLY “Watch out . . . ”. SLEEP “. . . zzzZZZZ”. KISS “Your lips here . . . ”.

In an embodiment of the present invention, other entity commands may include operations such as playing an MP3 file loudly, as in the following command: PLAY “http://host.com/music.mp3” “Loud”. A web site may be fetched by executing a command such as the following: HTTP GET “http://www.host.com/getPoints”. It should be noted that the content does not need to be in the network, but it could be the form PLAY “URI”, where the URI may point to a resource anywhere and in any protocol, for example, HTTP, ftp, local filesystem, etc.

Some examples of how entity language may be used are shown and described in FIGS. 5-8. FIG. 5 illustrates examples of entity actions that may be performed in accordance with an embodiment of the present invention. An entity 202 may be programmed to perform the SAY action, in which an entity displays a text message such as “Hello! How are you?”, as shown on the display 502 of an entity-enabled device.

In accordance with an embodiment of the present invention, an entity 202 may be programmed to perform a SMILE action, as shown on display 504 of an entity-enabled device. The SMILE action displays a smile expression on the head of the animated character shown with the entity. Optional text has been included in this particular SMILE command so that entity 202 is shown smiling and delivering the message “I want you to . . . ”

In accordance with an embodiment of the present invention, an entity 202 may be programmed with the RUN command. The RUN command displays the entity as performing a RUN action, as shown on the display 506 of an entity-enabled device. Here, the text string message “Run to our . . . ” has been added to the picture of an entity running across the display of the entity-enabled device. Parameters that may be used in connection with entity language, for example, this text string, may be added by an end user through end-user modification of an entity 202. Modification of entities is discussed further below.

In another example embodiment in accordance with the present invention, an entity 202 may be programmed to perform a HOUSE command, which shows a picture of a house on display 508 on an entity-enabled device. These actions may be performed in a series, as a show. For example, the actions shown in 502, 504, 506, 508 and 510 may comprise a show where the entity operates as a show host. At the end of the show described through the examples in FIG. 5, entity 202 may be programmed to perform the SAY action again, in which an entity displays the message “Bye bye”, as shown on the display 510 of an entity-enabled device.

FIG. 6 illustrates examples of entity body expressions that may be performed in accordance with an embodiment of the present invention. Entity body expressions may be implemented through the use of entity language commands. The effect of these commands is to cause the entity body 206 to perform a specified action.

For example, an entity command WAVE may be implemented to cause the hand of body 206 to make a waving action, as shown on the display 602 of an entity-enabled device. This waving action may also include a sound such as a whooshing sound that may be heard by the user of the entity-enabled device. An entity command RUN may cause the feet of an entity body to move up and down quickly to look like running, as shown on display 604 on an entity-enabled device.

The RUN command may also include playing the sound of running. The sounds that occur with the body expressions may be implemented in any available method for producing sounds on an entity-enabled device such as a phone. Some example sound formats may include WAV files, MIDI, MP3, proprietary sound file formats, or any other format that is compatible with the entity-enabled device on which the sound file may be run. For example, if the entity-enabled device has a plug-in that makes it compatible with a particular sound format, then an entity that uses that particular sound format may be run on that device. Sound files may be stored both in ROM, in which case they may not be changed. Alternatively, the sound files may be stored in persistent memory so that they may be overwritten and changed. For example, in an embodiment of the present invention, tunes or sounds may be available on the ROM of a terminal when it is purchased, and other tunes may be downloaded into the terminal's persistent memory later on.

Another example of a body expression in accordance with an embodiment of the present invention, the EXPLODE command may be applied to cause entity 202 to break up into pieces, as shown on display 606 on an entity-enabled device. The EXPLODE body expression command may be accompanied by the sound of an explosion on the entity-enabled device.

Other body expressions may be implemented include actions that involve both the head and body parts of the entity. For example, the CRAZY command causes the parts of the entity to make crazy moves, as shown on display 608 on an entity-enabled device. The CRAZY command may also include the playing of a crazy tune to accompany the body action shown. The body expression commands shown in FIG. 6 may be useful where the different parts of an entity may be better used as graphical representations to express ideas that are not easily implemented using commands that only display text, such as SHOW and SAY. Each of the body expression commands may also be accompanied by text messages similar to the ones shown in FIG. 5 described above.

FIG. 7 illustrates examples of entity facial expressions that may be performed in accordance with an embodiment of the present invention. Typically these commands affect how visual component 302 appears to the user of the entity-enabled device. For example, the SMILE command may be implemented to make a smile appear on the face or visual component 302 of the entity, as shown on display 702 of an entity-enabled device. The ANGRY command may be implemented to make the expressions shown on visual component 302 appear to have an angry demeanor, as shown on display 704 of an entity-enabled device.

Similarly, the HMMM command may be implemented to represent a thinking expression, as shown on display 706 of an entity-enabled device. The SURPRISE command may be implemented in such a way as to show an expression of surprise on visual component 302 of an entity, as shown on display 708 of an entity-enabled device. These facial expressions may be used with the visual component 302 alone, or in conjunction with commands that may be performed on body 304 of the entity 202. Depending on how they are implemented, the body 304 and visual component 302 may be scaled down or scaled up so that the entire expression appears on the display of the entity-enabled device.

FIG. 8 illustrates examples of other entity commands and parameters that may be mapped to entity actions in accordance with an embodiment of the present invention. Entity expressions may include a facial expression plus a parameter such as a text message, as shown by the implementation of the SLEEP command in which a visual component 302 is shown with its eyes closed, accompanied by text representing that the entity is sleeping (“. . . zzzZZZ”), as shown on display 806 in an entity-enabled device.

Body parts 304 of an entity may be used in a similar fashion. Entity expressions are not limited to operations that may be performed on a visual component 302 and a body 304 of an entity 202. Instead of displaying the body 302 and visual component 304 of an entity, other pictures may be displayed instead, and the entity itself may be invisible on the display of the entity-enabled device. These other pictures may be implemented as bitmaps that represent expressions that are not easily represented by the body 302 and visual component 304. These bitmaps may be stored in media pool 204. For example, entity commands FLOWER, FLY, and KISS may be represented by pictures of a flower, a bird, or lips, as shown in displays 802, 804, and 808 respectively. These entity commands may also include messages such as the text strings “28 and like a . . . ” as shown on display 802, “Watch out . . . ” as shown on display 804, and “Your lips here . . . ” as shown on display 808. Other commands may be executed that do not require the use of graphics. Some examples of such commands include VIBRATE, BROWSE or CALL.

II.C. Entity Variations

An entity 202 may implemented in a variety of ways, depending on the level of functionality and expression desired by the creator or modifier of the entity 202. Some of the basic variations include default entities, personalized entities, and entity behaviors that may be associated with device-specific characteristics, technology-specific characteristics, or programming-based functionality that is implemented in the entity methods 210 or entity brain 208. Examples of some of these variations are discussed below.

In an embodiment of the present invention, body 206 may include characteristics associated with the appearance of a body 304 and a visual component 302. An example of these characteristics and how they may be modified is shown and described further in the discussion of FIG. 3 above. Modifying body characteristics and their appearance may be used extensively in connection with the use of advertising entities discussed further below.

An entity 202 may include any subset of the components described above or all of them, depending on the desired content and functionality, and on the functionality available to the entity-enabled device on which the entity is used. For example, a subset called a default entity 238 may be defined as including a media pool 204 and a body 206. A default entity 238 does not need to include a brain 208, methods 210, or bookmarks 212. In situations where an entity includes more functionality than a particular entity-enabled device can handle, an entity-enabled device may interpret the entity to the extent that the functionality is available.

The behavior of an entity 202 may be a function of the device on which it is located. Device-specific characteristics include, for example, the wireless terminal type and features, how much memory and processing power are available, and what the size of the display is. A default entity 238 may be persistent in an entity-enabled device, and may act as a “mascot” to implement features that are specific to that particular entity-enabled device. For example, an entity-enabled device such as a Nokia 3310 phone may have a default entity built into it that implements or works with features that are specific to that phone. Features that are specific to an entity-enabled device may include, for example: use of the alarm feature to send a different alarm tone based on what time the alarm is set for, or to make the alarm go off when the battery of the entity-enabled device is getting low or needs to be replaced.

An entity may react to device specific events in different ways. For example, a default entity may be given a sequence of entity commands to perform when the battery is low. An example of an implementation of such a command is ‘JUMP.SAY “Gimme power!”.TIRED’. This command will display an entity that jumps and says “Gimme power!” in response to detecting that the entity-enabled device is low on power. A user may select entity commands to implement this sort of functionality, may program the entity himself, or may download the commands from a location on the network such as an entity server. The user may save the commands to his entity-enabled device for use whenever the device-specific triggering event occurs to activate the sequence of entity commands.

The capability and features that are available in connection with an entity 202 may be a function of the available technology. For example, in a communication network having higher bandwidth, there may be a performance increase in the processing of large items in the media pool 204. At least three levels of technology are anticipated to be used in connection with various entity messaging system implementations. For example, in a messaging embodiment, an entity 202 may have limited functionality and available media content due to limited resources in the entity-enabled device. As entity-enabled devices such as mobile phones become more advanced and include more resources such as memory and processing power, and as the bandwidth of networks increases, the messaging embodiment may phased out by a multimedia embodiment. In a multimedia embodiment, richer media content may become more practical to use as a result of improvements in technology. Still further, as the technology develops, an agent embodiment may become available that will allow entities to be used as agents that communicate with each other.

III. Usage of Entities

Entities may be used in numerous ways. They may be created, modified, sent and received, downloaded from remote locations such as web sites, and tracked for purposes of billing, advertising, and obtaining information about the users who download the entities. The sections below describe some entity usage scenarios in accordance with embodiments of the present invention.

III.A. Creation and Modification of Entities

Entities may be created and modified using a suite of entity tools. These entity tools are defined by a software architecture, which is described further below in the discussion of FIG. 9. When an entity is ready to be invoked, it is executed in an entity execution environment that is described further below in the discussion of FIG. 10.

III.A.1. Entity Tools

An entity 202 may be created or modified through the use of entity tools. Referring to FIG. 9, software architecture 900 in accordance with an embodiment of the present invention is shown. Note that the blocks illustrated in FIG. 9 may be embedded in the software of a device to make the device into an entity-enabled device. Software architecture 900 may be used for creating, modifying, and invoking entities. Software architecture 900 may include communications control 902; entity player 904; hardware control 906; content control modules such as graphics control 908 and sound control 910; entity editor 912; storage 914.

An entity 202 may be stored over logical connection 924 in entity storage 914 by entity editor 912. Entity editor 912 may be used to make additions or modifications to an entity 202. The Entity Editor 912 may be used to create an Entity command sequence (not shown). Typically, creating an entity command sequence includes adding the MAIN method to the Entity structure. The MAIN method is described in more detail above in the discussion of FIG. 2.

Entity editor 912 may send the entity 203 to a communications control 902 via logical connection 920. Entity player 904 may get or receive an entity 202 from storage 914 via logical connection 922. Entity player 904 may also receive an entity 202 from communications control 902 via logical connection 926.

Entity player 904 interprets an entity command and plays or executes it, passing event requests to different control blocks. For example, the entity player 904 may send a “draw line” request to the graphics control 908 via logical connection 930. Entity player 904 may also receive a hardware event from hardware control 906 via logical connection 928. Hardware control 906 may receive a hardware event from entity player 904 via logical connection 932 and cause the hardware event to happen on entity enabled device 104 via logical connection 938. Hardware control 906 may also listen for hardware events from entity enabled device 104 over logical connection 940, and then forward that hardware event to entity player 904 via logical connection 928.

If entity 202 contains content such as graphics or video, entity player 904 may send a message to graphics control 908 via logical connection 930 telling the graphics control 908 to perform the desired action. For example, if entity 202 contains graphics, entity player 904 tells graphics control 908 to perform a “draw” operation on entity enabled device 104 via logical connection 934 so that the graphics are drawn on the display of entity enabled device 104.

If entity 202 contains sound content, for example MIDI or MP3, then entity player 904 may send a message to sound control 910 via logical connection 936. In response to the message of entity player 904, sound control 910 may play the sound content on entity-enabled device 104 via logical connection 942.

The Entity player 904 is a language interpreter. It receives an entity command sequence (a method from the Entity) to be run and parses that sequence. In parsing the sequence, the entity player 904 finds and validates the commands in the sequence. The entity player 904 then interprets the commands. When interpreting a command, the entity player 904 looks at the instincts 216 to find out what actions 214 are needed to execute the command and in what order they need to be executed. The entity player 904 then makes calls to the different control parts and plug-ins to run the actions 214.

Examples of different control parts and plug-ins may include the sound control 910 (which may include, for example an MP3 player) and the graphics control 908 for drawing lines, etc. In an example embodiment of the present invention, the entity player 904 may use text input and attempt to create a visualization of that text input through the use of entity actions 214 and entity methods 210. The entity player 904 may attempt to find a match between words contained in the text and words that are associated with entity actions 214. For example, if the text message is “Smile, you have just received an entity!” then the entity player 904 may parse the word “smile” in the text message and then attempt to run the SMILE command.

When the user is finished creating and/or modifying the entity, a user may preview an entity 202. The user may invoke the entity so that it performs an entity method 210 that user designed or placed into the entity. The user may do so by calling the entity player 904 from the entity editor 912 and by invoking the entity 202 from there. If the entity 202 performs as expected, then the user is ready to send the entity 202 or place it in storage somewhere.

III.A.2. Entity Execution Environment

FIG. 10 is a diagram illustrating an entity execution hardware environment 1000 in accordance with an embodiment of the present invention. Entity execution hardware environment 1000 may be used to implement an entity reply mechanism. Hardware environment 1000 may include communications hardware 1002, one or more processors 1004, storage 1006, user I/O hardware 1010, and other hardware 1008. Processor 1004 may be any processor or plurality of processors that are suitable for entity processing, for example, one or more general-purpose microprocessors, one or more DSP processors, or one or more graphics processors.

Processor 1004 may get and store entities 202 from memory 1006 via logical connection 1012. Memory 1006 may be implemented as, for example, ROM, RAM, Flash, DRAM, SDRAM, or any other memory that is suitable for storage devices. Input and output events are provided to processor 1004 by communications hardware 1002 via logical connection 1014. Communications hardware 1002 may include any devices that may be suitable in an entity processing environment. For example, Communications hardware 1002 may support Bluetooth, Infrared, different wireless and wired networks, and messaging.

User I/O hardware 1010 provides input and output of user interaction events to processor 1004 via logical connection 1018. User I/O hardware 1010 may include for example, a screen or display, a keypad, microphone, or recording device. Other hardware 1008 may provide input and output of hardware events to processor 1004 via logical connection 1016. Other hardware 1008 may include for example, a battery, antenna, microphone or recording device.

Depending on the bandwidth available in the hardware system, a number of entity options may be chosen in order to provide optimization for downloading and invoking an entity. A self-contained entity 202 may provide a mechanism for transport layer optimization by allowing the creator of an entity to decide which content in the media pool 204 is sent as part of an entity 202 and which content is downloaded only when needed. For example, after previewing an entity, the entity player may provide functionality that asks the user whether he wants to send only part of the entity instead of sending the entire entity, by selecting only a subset of commands. By only including a subset of the entity's available commands rather than the entire entity command set, a level of optimization could be provided in the entity messaging system. In another example in accordance with an embodiment of the present invention, entity commands may be deleted from the list of commands to be downloaded as part of downloading an entity from a server. Also, entity commands that reside in an entity that is already on a user's entity-enabled device may be deleted in order to optimize bandwidth and resource usage. If the user later decides he wants those entity commands later on, he may modify the entity and add those commands through the use of the entity editor 912.

III.A.3. Usage with No Modification

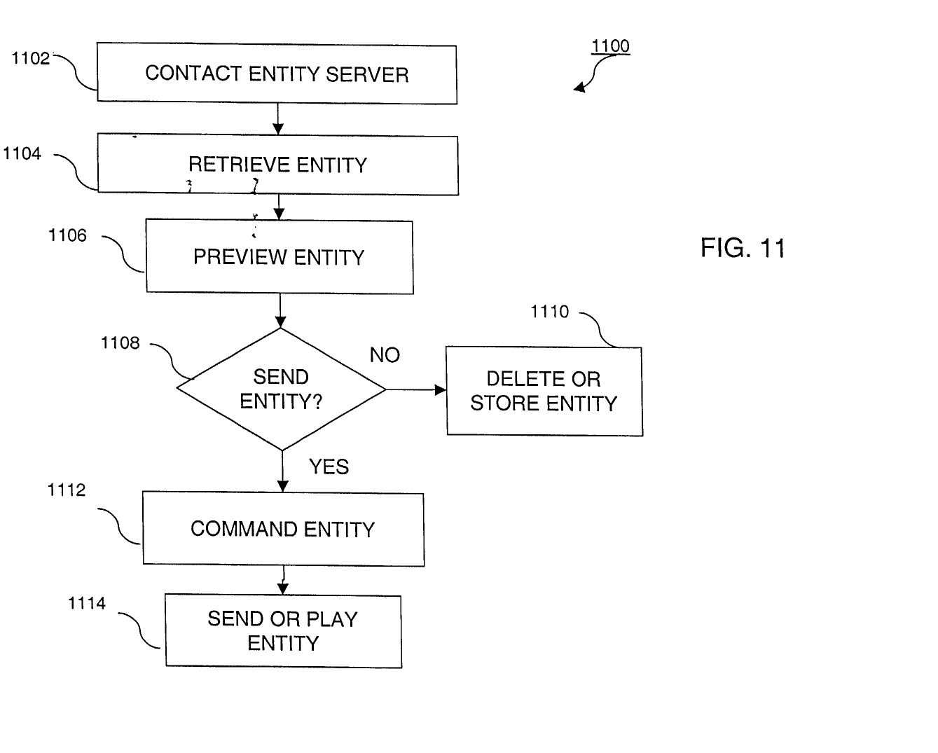

An entity 202 may be used with no modification prior to being sent to another user. This is one of the most basic uses of an entity 202. FIG. 11 illustrates a flowchart 1100 corresponding to steps in a method for entity messaging in accordance with an embodiment of the invention. A user contacts a server to obtain an entity 202, step 1102, or alternatively the user may already have an entity 202 available. The user retrieves the entity, step 1104. Then the user has a choice. The user may preview the entity, step 1106 and then decide whether or not to send the entity, step 1108. If the user does not wish to send the entity, the user may delete the entity or store the entity, step 1110. If the user wishes to send the entity, he may command the entity, step 1112, and then send the entity, step 1114. The user may send the entity 202 to any accessible location, for example, to another user.

III.A.4. Creation and Personalization

An entity 202 may be updated and personalized using creation tools that allow a user to make changes to an entity that they have downloaded. These creation tools may provide functionality that provides a “do-it-yourself” capability for creating and modifying entities. A business model may be created in which a user pays a fee in exchange for being able to create a personalized entity, for example a “self-made” or “do-it-yourself” entity. In this scenario, the user might not pay for the creation of the entity, if the tools and creation are given away free, but the user might pay a downloading fee for the Entity on which his “self-made” entity is created.

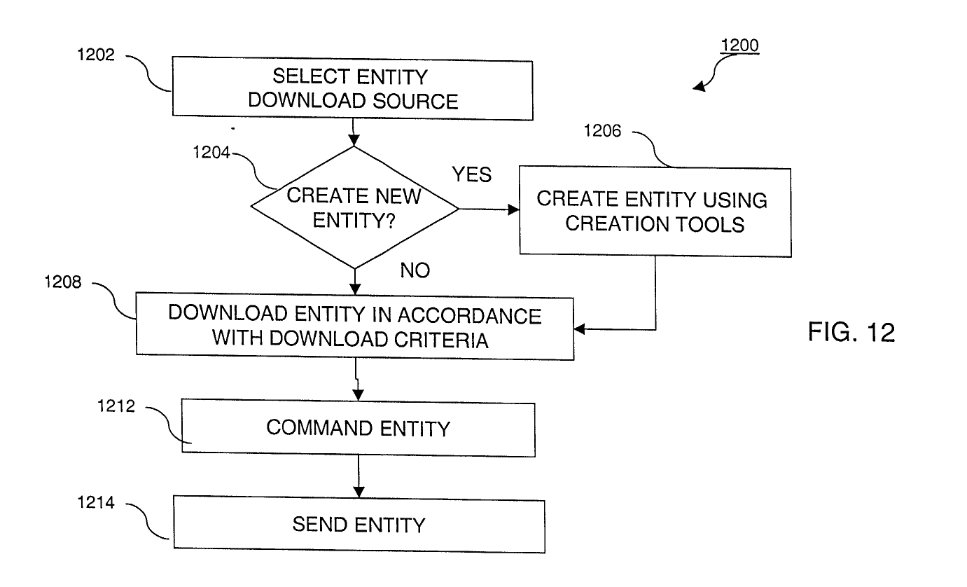

FIG. 12 illustrates a flowchart 1200 showing steps that may be performed in a method for entity personalization in accordance with an embodiment of the present invention. In step 1202, an entity is selected from a source, for example a download source such as Club Nokia (reachable on the Internet at www.clubnokia.com). A decision is made, step 1204 as to whether or not a new entity 202 is being created. If a new entity is being created, then in step 1206, an entity is created using entity creation tools, as described above in the discussion of FIG. 9. Then processing continues at step 1208.

If an entity is not being created, then the entity may be downloaded, step 1208, in accordance with some downloading criteria. The download criteria may be predetermined, or may be determined in association with some other relevant parameter or criteria. After downloading, the user commands the entity, step 1212. Commanding the entity may mean that the user selects a set of commands that the entity will perform when it is received by another user. When the commanding step is complete then the entity is ready to be sent or stored for later sending, step 1214.

III.B. Distribution of Entities

Entity 202 may be downloaded and used for purposes including advertising, entertainment, and fundraising. For example, an end user may select an advertising entity from a dedicated entity distribution site for free and then download that entity to his own entity-enabled device. In a business model employing advertising entities, an advertiser may pay a fee to an entity distribution site in exchange for making the advertising entities available for users to download from the distribution site. The advertiser may pay per downloaded Entity. A tracking message may be used to track if Entities have been forwarded between users and therefore to find out the correct number of entities that have been downloaded.

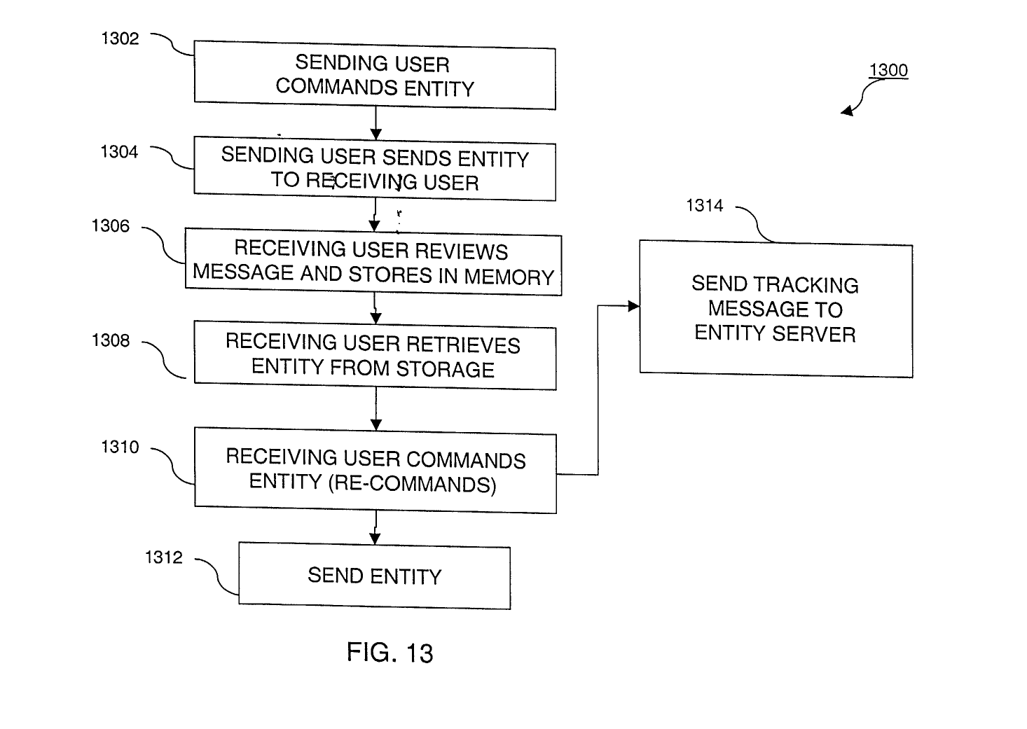

Referring to FIG. 13, a flowchart 1300 illustrates steps that may be performed in a method for tracking entities 202 in accordance with an embodiment of the present invention is described. A sending user commands an entity, step 1302. The sending user may command a new entity or alternatively, the sending user may command an entity that the sending user retrieves from a location that provides entities for downloading. For example, the sending user may download an entity from a server that stores advertising entities, and then the sending user may take that entity and command it prior to sending it to another user. After the sending user commands the entity, the sending user may send the commanded to entity to a receiving user, step 1304. The receiving user then may review the message and if desired, store the message in memory, step 1306. The receiving user may then retrieve the entity from storage, step 1308. The receiving user may command the entity as desired (or re-command the entity), step 1310, to prepare for sending the entity to another user or back to the original sender.

The receiving user may then send the re-commanded entity, step 1312. At or around the time the receiving user sends the entity on to another user, a tracking message may be sent to the entity server, step 1314, to indicate that the entity has been forwarded on to another user or that another user has retrieved the entity from the entity server. This tracking message may also indicate which of a plurality of available types of entities downloaded by the user. The modified entity may be sent to another user, step 1306. The Entity server then creates billing logs based on the sum of the downloaded Entities and tracking messages per Entity. These billing logs may be used for billing an advertiser for the distribution of entities relating to a particular advertising, or may be used to track information relating to entity downloads.

III.B.1. User to User Communication

A typical usage case for entity messaging is user-to-user communication. An example of this case is illustrated by flowchart 1100 of FIG. 11, in which the entity is not modified prior to sending.

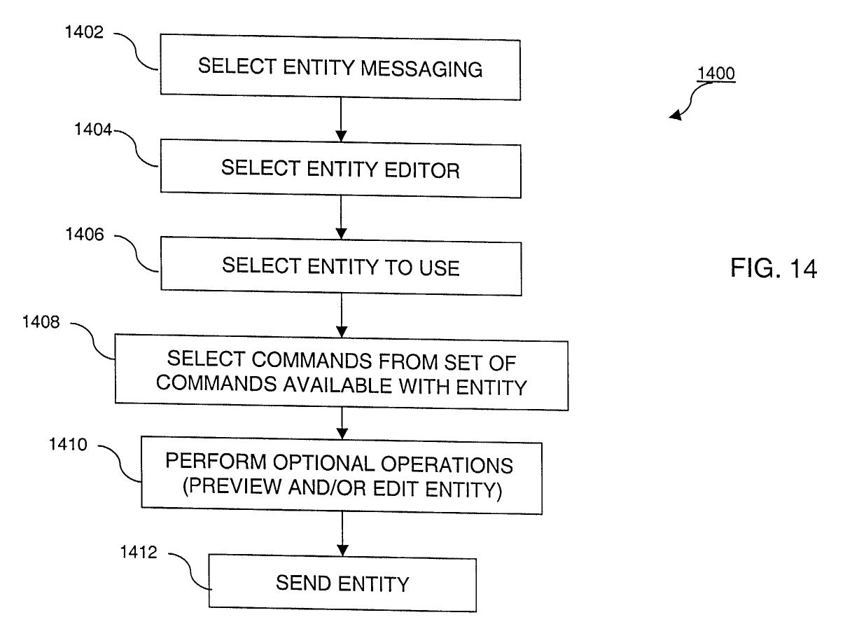

If the sending user decides to modify the entity 202 prior to sending to a receiving user, then flowchart 1400 is more applicable. Flowchart 1400 in FIG. 14 illustrates steps that may be performed in a method for entity messaging in an embodiment of the present invention. A sending user selects entity messaging, step 1402. The user may optionally select the entity editor, step 1404, in order to create and/or make changes to the entity 202. If the sending user wishes to base his new entity on an existing entity then he may select an entity to use, step 1406.

The user may then personalize the entity by creating an entity command set, step 1408. Step 1408 may include selecting commands from a set of commands that are available with an entity. Step 1408 may also include adding parameters to the commands that are selected. Step 1408 may also include adding appropriate values and/or variables to the parameters and to the commands. After selecting entity commands, the user may perform other optional operations, step 1410. These optional operations may include previewing the entity in order to make sure that, when invoked, the entity behaves as the user expects. The user may also decide do continue editing the entity at this point. When the user is satisfied with with the commands and parameters that he has selected, the user may store or send the entity, step 1412.

III.B.2. Advertising Using Entities

In an embodiment of the present invention, entities may be used for advertising. A user may select a sequence of entity commands from a server, download those commands over the network, and save them to his entity-enabled device or send them to another user. In an advertising context, the party that places the specific entity commands on the network may collect a fee from the user or from an advertiser at the time of downloading. These commands may include an advertiser-specific element in them that appears when the user invokes the entity on his entity-enabled device. For example, the advertiser's name and/or logo may appear on the display of the entity-enabled device, or the advertising company's jingle may be played in the background as the entity is invoked. How the advertising entities are distributed is discussed further above in the section on entity distribution.

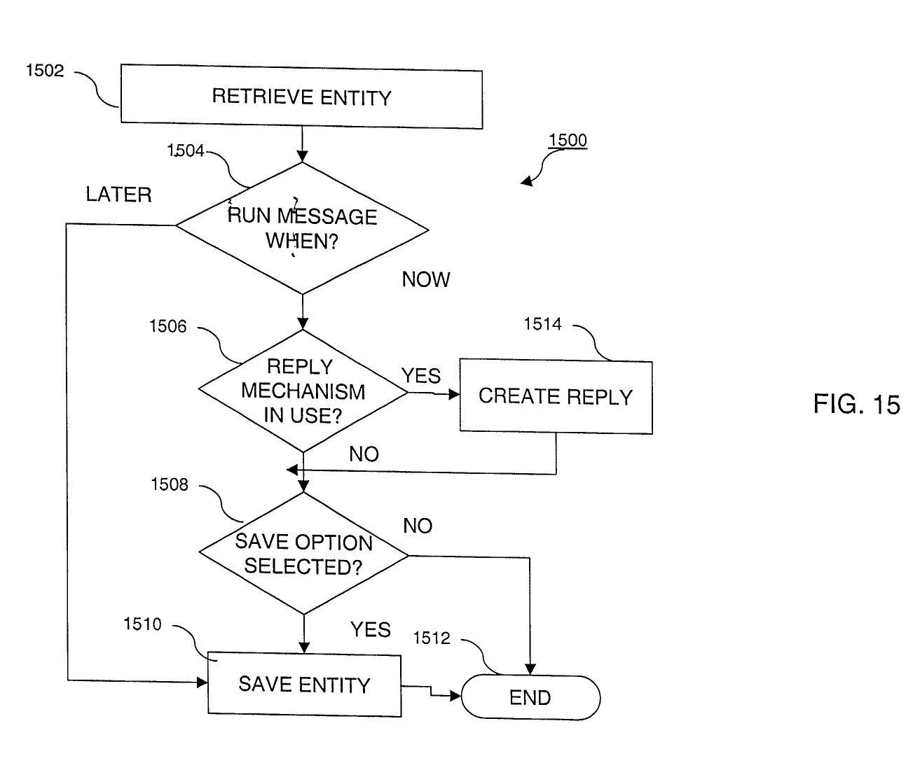

FIG. 15 shows a flowchart 1500 illustrating steps that may be performed in an entity reply mechanism in accordance with an embodiment of the present invention. This entity reply mechanism may be used in connection with a method for entity advertising in accordance with an embodiment of the present invention. An entity may be retrieved, step 1502, from a location that may act as a repository or storage for entities. For example, the location may be an advertiser's web site, a web site that includes content that is targeted to a market that an advertiser is interested in, a user's web page or entity-enabled device, or any other location capable of storing entities.

After retrieving the entity, step 1502, a user may decide when to invoke the entity, step 1504. If the use wishes to run the entity in the present, then the NOW decision branch is taken and the entity is invoked, step 1506. Otherwise, if for example, the user wishes to save the entity for later invocation, then the LATER decision branch is taken and the entity is saved, step 1510. After the user runs the entity, step 1506, he may decide whether or not to save the entity, step 1508. This decision may be implement in numerous ways, for example, the user may select a SAVE option or set a SAVE flag that tells the entity messaging system that the user desires to save the entity after invocation. If the user decides not to save the entity, then processing is complete, step 1512. Otherwise, if the user decides to save the entity, then a save operation is performed, step 1510, after which processing is then complete, step 1512. Numerous other methods for implementing advertising entities are contemplated by embodiments of the present invention, including providing tracking and billing capability as described in the discussion of FIG. 13 above.

III.B.3. Interactive Use of Entities

In an embodiment of the present invention, a system and method for entity messaging may provide capability for a plurality of entities to interactively communicate with each other through the use of a central communication unit. The central communication unit may include an entity-enabled program that enables interactive communication among entity-enabled devices. This interactive communication may provide functionality that allows the entity-enabled devices to play an interactive game. The game may be pre-installed in the central communication unit, or may be loaded into it. For example, the game may be downloaded from another location such as the network or some other storage or memory device. The central communication unit may also be referred to as a gamebox or an interactive entity communication device.

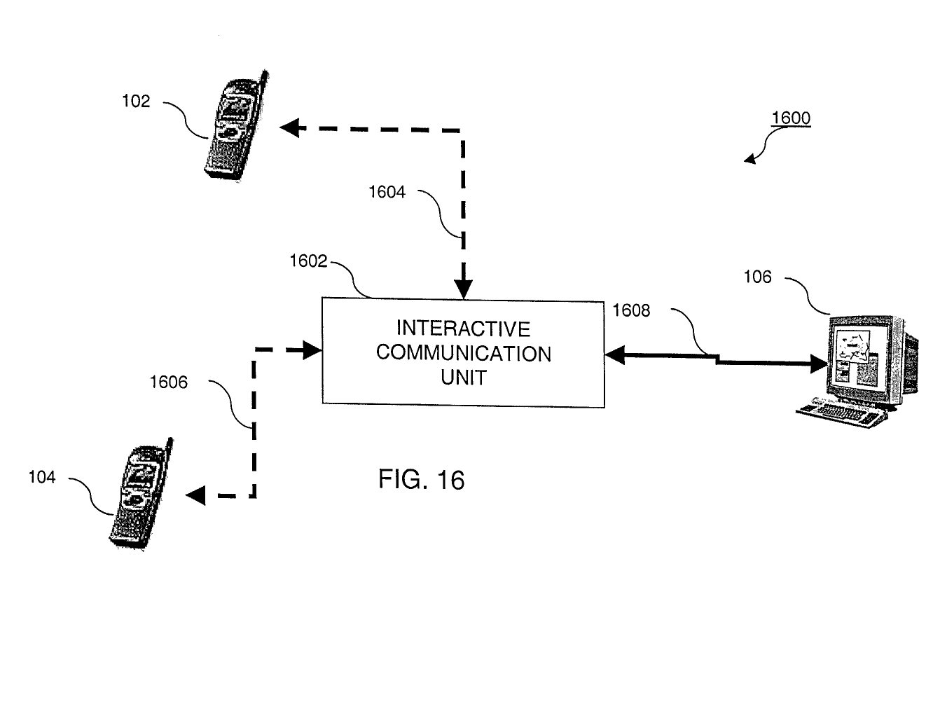

Referring to FIG. 16, block diagram 1600 illustrates a system for interactive entity messaging in accordance with an embodiment of the present invention. An interactive communication unit 1602 provides capability for one or more entity-enabled devices, 102, 104, 106 (a server 108 may also be used but is not shown) to interactively communicate entity messages. For example, entity-enabled device 102 may communicate with interactive communication unit 1602 and entity-enabled devices 104 and 106 via connection 1604. Connection 1604 may be any connection appropriate for entity messaging, including a wireless or a wireline connection. Similarly, entity-enabled device 104 may communicate with interactive communication unit 1602 and entity-enabled devices 102 and 106 via connection 1606. Connection 1606 may be any connection appropriate for entity messaging, including a wireless or a wireline connection. Similarly, entity-enabled device 106 may communicate with interactive communication unit 1602 and entity-enabled devices 102 and 104 via connection 1608. Connection 1608 may be any connection appropriate for entity messaging, including a wireless or a wireline connection.

III.B.4. Use With Devices That Are Not Entity-Enabled

In a system and method for entity messaging in accordance with an embodiment of the present invention, certain wireless terminal models may be used as mass-market terminals that are targeted for a particular market, for example, teenagers and young adults, even if they are not entity-enabled devices. This level of entity messaging may be performed without making infrastructure changes. Entity servers 108 may be hosted in the network and may run a service that imitates the functionality of an entity-enabled terminal. This enables users who have devices that are not entity-enabled to view their entity messages by forwarding them to an entity-enabled device such as an entity server 108 or a personal computer 106.

When a user receives an Entity message that his wireless terminal cannot understand or interpret, the user may forward the entity message to an Entity server 108, get a unique identification (ID), and use his personal computer 106 to view the message. The unique ID may be created using a server application, may be sent over a network to an entity-enabled device, and then stored as part of the default entity 238. The ID eliminates the need to enter user information using the terminal keypad and may provide a level of anonymity for the user of the device. However, if the user has an entity-enabled device such as a wireless terminal 102, 104, then the user may simply run the Entity on the wireless terminal.

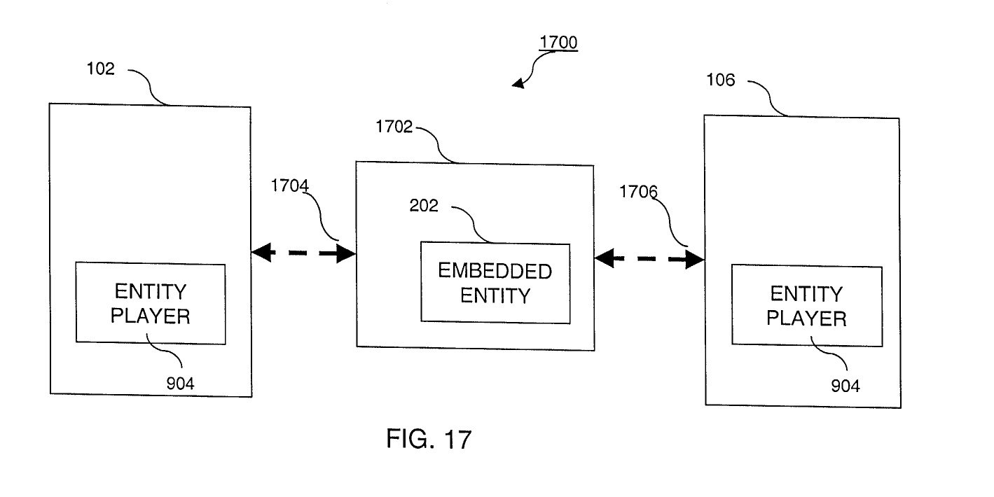

Referring to FIG. 17, a block diagram 1700 illustrates a system and method for entity discovery in accordance with an embodiment of the present invention. An entity discovery system 1700 may allow an entity-enabled device 102, 106 to become the user interface for a device 1702 that has an entity 202 embedded in it. An entity-enabled device provides capability for invoking entities, and typically includes an entity player 904 for that purpose. A device that is not entity-enabled may be used to store entities that may be downloaded and run on other entity-enabled devices such as 102 and 106. Device 1702 includes a communication capability for accessing the device, and a storage or memory where the entity 202 may be stored. The embedded entity 202 may later be “discovered” on device 1702 and invoked by an entity-enabled device 104, 106. Device 1702 may be any device that includes communication capability and storage. For example, device 1702 may be a VCR. An entity-enabled device 102 may send an entity 202 over a connection 1704 to device 1702, whereupon entity 202 is embedded in the device 1702. Embedded entity 202 may reside in the storage of device 1702. The embedded entity 202 may then be retrieved over a connection 1706 and invoked by entity-enabled device 106. Similarly, an entity-enabled device 106 may send an entity 202 over a connection 1706 to device 1702, whereupon entity 202 is embedded in the device 1702. Embedded entity 202 may reside in the storage of device 1702. The embedded entity 202 may then be retrieved over a connection 1704 and invoked by entity-enabled device 104.

III.B.5. Other Uses for Entities

In an embodiment of the present invention, a system and method for entity messaging may include the use of agent entities. An agent entity may be implemented with “intelligence” in that the entities are programmable and provide additional features. In an example embodiment of the present invention, agent entities may be programmed to provide entity-to-entity communication in which a first entity located on a first entity-enabled device may communicate with a second entity on a second entity-enabled device.

Alternatively, agent entities may provide entity-to-service communication (or service-to-entity communication) in which agent entities may directly contact and communicate with services such as Internet services. For example, an agent entity may be programmed to search the Internet for a particular item that a user wishes to purchase based on criteria such as cost. When the agent entity finds a particular item or collection of items, the agent entity may go out and purchase that item or make arrangements to purchase the item without user intervention. These agent entities may be programmed in any appropriate language, for example Java, to provide for more interactions among entities and to allow for dynamic downloading of new features.

Entities may be used for a wide variety of applications that are not described in great detail here but are nonetheless consistent with the spirit of embodiments of the present invention. For example, entities may include “bags” of content that may be sent from user to user, and may include security associated with the content to protect the user's privacy or to prevent unauthorized parties from accessing the content that is being sent. In another application, entities may be used in connection with toys to provide entertainment and amusement in addition to providing enhanced messaging capability.

It is to be understood that the foregoing description is intended to illustrate and not limit the scope of the invention, the scope of which is defined by the appended claims. Other aspects, advantages, and modifications are within the scope of the following claims. Although described in the context of particular embodiments, it will be apparent to those skilled in the art that a number of modifications to these teachings may occur. Thus, while the invention has been particularly shown and described with respect to one or more preferred embodiments thereof, it will be understood by those skilled in the art that certain modifications or changes, in form and shape, may be made therein without departing from the scope and spirit of the invention as set forth above and claimed hereafter.

What is claimed is:

1. A system for commanding an entity, comprising:
an entity player for invoking an entity, wherein the entity includes a plurality of methods;
an entity editor connected to the entity player; and
at least one control device connected to the entity player,
wherein the entity player invokes the entity methods in accordance with the control device.

2. A method for commanding an entity, comprising:
selecting an entity wherein the entity includes a plurality of commands that are associated with the entity; and
selecting at least one entity command.

3. The method of claim 2, wherein the step of selecting the entity commands is performed through the use of an entity editor.

4. A method for commanding an entity, comprising:
downloading an entity, wherein the entity is associated with a plurality of commands;
opening the entity in an entity editor to determine the plurality of commands associated with the entity;
selecting at least one command; and
constructing a message from the selected command.

5. A method for interpreting an entity, comprising:
retrieving, by an entity-enabled device, an entity having a plurality of commands wherein the entity-enabled device includes an entity player for interpreting commands;
determining, by the entity player, whether the commands are compatible with the entity-enabled device;
interpreting, by the entity player, the compatible commands on the entity-enabled device.
